(19) United States
(12) Patent Application Publication
(10) Pub. No.: US 2005/0013203 A1
(43) Pub. Date: Jan. 20, 2005

(54) Portable watch

(76) Inventors: Haruki Hiranuma, Chiba-shi (JP); Hisamitsu Yoshikawa, Chiba-shi (JP)

Correspondence Address: ADAMS & WILKS, 31st Floor, 50 Broadway, New York, NY, 10004, US

(21) Appl. No.: 10/784,424

(22) Filed: Feb. 23, 2004

(30) Foreign Application Priority Data
Mar. 10, 2003 (JP) 2003-063251

(51) Int. Cl. F16L 11/00; G04B 5/00; G04C 1/00; G04B 3/00; A44C 5/00; G04B 37/00

(52) U.S. Cl. 368/206

(57) ABSTRACT

To provide a portable watch enabling component exchange around a crown when the screw lock capability is reduced. A case band is provided with a pipe-attachment hole opening toward an intracase-band plane and an extracase-band plane, and a pin-receiving groove opening toward this hole, the intracase-band plane, and the extracase-band plane. A winding stem pipe is provided with an intracase-band end section to be arranged inside of the case band including an engagement groove, an extracase-band end section to be arranged outside of the case band including a male screw section to be screwed together with a crown in a removal manner, and a pin-receiving groove opening toward the outer rim plane of the pipe and facing to a receiving groove. The pipe is playably inserted into the hole in a removable manner from the outside of the case band. A rotation-stop pin for preventing the pipe from rotating is placed across both receiving grooves. A pipe stopper for preventing the pipe from being disengaged is engaged to the engagement groove in a removable manner. With such a structure, the crown and the pipe can be separately exchanged.

### BACKGROUND OF THE INVENTION

1. Field of the Invention

The present invention relates to a portable watch in which, structurally, a crown is so retained as not to accidentally rotate.

2. Description of the Prior Art

In a portable watch exemplified by a divers watch, adopted is the structure in which a crown is locked utilizing screw engagement (such a structure is referred to as screw lock in this specification) to prevent the crown from accidentally rotating when the portable watch is carried around.

The screw lock structure is the structure in which a case band including a watch movement is attached with a winding stem pipe, and to a male screw section formed to the outer rim of an extracase-band end section of the pipe, a female screw section locating at a crown main section to be fit to the extracase-band end section is screwed. With such a structure, under normal circumstances, the crown main section is screwed into the outer rim of the extracase-band end section so that the crown is locked. In order to operate the watch movement, the crown main section is unscrewed from the male screw section, and after pulling out the crown, a winding stem locating inside of the winding stem pipe can be operated for rotation.

With the conventional portable watch of such a screw lock structure, generally, a winding-stem-pipe-attachment section can be waterproof by brazing the winding stem pipe to the case band (see JP-A-57-46181 (from 8th line, right column, page 1 to 7th line, left column, page 2, FIGS. 1 and 2) as an example).

Other than the above, also known is another portable watch of a type aiming for waterproof capability of the winding-stem-pipe-attachment section. Therein, in the middle part of the winding stem pipe in the axial direction, a male screw section is provided separately from another male screw section to which a crown is screwed together so that the male screw section is screwed into the pipe-attachment hole of the case band, and after this screwing is completed, a waterproof gasket is sandwiched between the case band and the winding stem pipe.

In a portable watch with the screw lock structure, repeatedly operating the crown for rotation will cause both the screwing-together female screw section of the crown and the male screw section of the winding stem pipe to be worn out or chipped, resultantly reducing the screw lock capability.

In such a case, the portable watch of JP-A-57-46181 in which the case band is brazed with the winding stem pipe does not allow exchange of components locating close to the crown if requiring removal of the winding stem pipe from the case band. There is thus no choice to exchange the watch exterior assembly including the case band. As such, there has been a demand for improvement thereof.

With a watch having a winding stem pipe screwed into a case band, it has been considered that, in principle, exchange is possible for components including the winding stem pipe, locating close to the crown. Even with such a structure, however, the winding stem pipe receives rotation forces every time the crown is screwed into the winding stem pipe or every time this screwing is unscrewed. Accordingly, the screwing of the winding stem pipe into the case band becomes loose, resultantly possibly causing the waterproof capability achieved by a waterproof gasket to be reduced.

As measures against that, adhesive filling is sometimes done to the section at where the winding stem pipe and the case band are screwed together. If adhesive is used for attachment as such, the winding stem pipe becomes difficult to be removed from the case band, and in practical sense, exchange of components locating close to the crown becomes impossible. As a result, there has been no choice to exchange the watch exterior assembly including the case band if the screw lock capability is reduced. As such, there has been a demand for improvement thereof.

An object to be achieved by the present invention is to provide a portable watch capable of exchange of components locating close to the crown when the screw lock capability is reduced.

### SUMMARY OF THE INVENTION

In order to achieve the above object, the present invention is characterized in that, a case band is provided with a pipe-attachment hole opening toward both an intracase-band plane and an extracase-band plane, and a pin-receiving groove opening toward the pipe-attachment hole and also toward at least either the intracase-band plane or the extracase-band plane. A winding stem pipe is playably inserted into the pipe-attachment hole in a removable manner from outside of the case band. And this winding stem pipe is so structured as to include an insertion section including an intracase-band end section with an engagement groove to be arranged inside of the case band, an extracase-band end section including a male screw section to be screwed together with a crown in a removable manner for arrangement outside of the case band, and another pin-receiving groove opening toward an outer rim plane of the insertion section and facing to the above-described pin-receiving groove. Further, a rotation-stop pin is arranged across both of the pin-receiving grooves of the case band and the winding stem pipe to prevent the winding stem pipe from rotating, and a pipe stopper is engaged with the engagement groove provided to the intracase-band end section in a removable manner to prevent the winding stem pipe from being disengaged.

In the present invention and each invention in the below, the case band and the winding stem pipe can be preferably made with metal exemplified by materials such as stainless steel. However, this is not restrictive, and may be made of synthetic resin. In the present invention, the expression of the winding stem pipe being “playably inserted” into the pipe-attachment hole denotes the insertion state that the winding stem pipe is inserted into the pipe-attachment hole with not press-fitted, and the insertion section is allowed to be inserted or removed to/from the attachment hole from the extracase-band side. Under this insertion state, providing a slight gap (play) between the winding stem pipe and the pipe-attachment hole is considered preferable. However, substantially, there may be no need for this gap. In the present invention and each invention in the below, the pipe stopper may be substituted by a C-shaped or E-shaped stopper or an annular nut capable of functioning as a stopper component on its own, and the like. Other than those, it is also possible to use, as a stopper, a board section with a U-shaped groove in a piece formed to an inner frame made of synthetic resin and others arranged in the intracase-band side (inner space of the case band) for the purpose of supporting a watch movement. If this is the case, the board section can be caused to function as a pipe stopper by fitting the U-shaped groove into the engagement groove of the intracase-band end section of the winding stem pipe. Moreover, depending on the type of the pipe stopper, the engagement groove of the intracase-band end section can be formed by an annular groove or a screw groove.

In the present invention, the winding stem pipe playably inserted into the pipe-attachment hole of the case band is fixed to the case band not to rotate by the rotation-stop pin, which is snagged on both the pipe and the case band. At the same time, it is prevented from being disengaged on the extracase-band side by the pipe stopper locating in the intracase-band side. That is, the winding stem pipe is attached to the case band without fixation. As such, in the respect of maintenance, with the pipe stopper removed, the winding stem pipe playably inserted into the pipe-attachment hole can be pulled out to the extracase-band side.

In a preferable embodiment of the present invention, the pin-receiving groove of the case band is made open toward the intracase-band plane, and the pin-receiving groove of the winding stem pipe is made open toward the tip plane of the insertion section. Therefore, it is considered superior in the respect that the rotation-stop pin can be inserted or removed to/from the intracase-band side without being disturbed by the extracase-band end section of the winding stem pipe.

In the preferable embodiment of the present invention, the rotation-stop pin is sandwiched, in an axial direction, between a groove end of the pin-receiving groove of the winding stem pipe locating closer to the extracase-band end section and the pipe stopper. Accordingly, it is considered superior in the respect that, in order not to disengage the rotation-stop pin and to retain it at any predetermined position, there is no need to include a component specifically designed therefor.

Moreover, in order to achieve the above object, the present invention provides a case band with a noncircular pipe-attachment hole opening toward an intracase-band plane and an extracase-band plane. Therein, characteristically, provided are: an insertion section having playably inserted, to the pipe-attachment hole from outside of the case band, a winding stem pipe having an outer rim being noncircular in shape corresponding to the pipe-attachment hole, and including an intracase-band end section with an engagement groove to be arranged inside of the case band; and an extracase-band end section including a male screw section to be screwed together with a crown in a removable manner. Further, a pipe stopper is engaged with the engagement groove provided in the intracase-band end section in a removable manner to prevent the winding stem pipe from being disengaged.

In the present invention, the outer rim plane of the winding stem pipe being noncircular in shape includes the shape formed with one or more groove threads or convex threads extending to the outer rim plane of the winding stem pipe in the axial direction, or a polygon. Similarly, the pipe-attachment hole to be playably inserted with the winding stem pipe being noncircular in shape includes the shape formed with one or more convex threads or groove threads extending to the inner rim plane of the pipe-attachment hole in the axial direction, or a polygon.

In the present invention, the winding stem pipe playably inserted into the pipe-attachment hole of the case band is fixed to the case band not to rotate by the fact that the pipe and the pipe-attachment hole both being noncircular in shape. At the same time, it is prevented from being disengaged on the extracase-band side by the pipe stopper locating on the intracase-band side. That is, the winding stem pipe is attached to the case band without fixation. As such, in the respect of maintenance, with the pipe stopper removed, the winding stem pipe playably inserted into the pipe-attachment hole can be pulled out to the extracase-band side.

### BRIEF DESCRIPTION OF THE SEVERAL VIEWS OF THE DRAWINGS

A preferred form of the present invention is illustrated in the accompanying drawings in which:

FIG. 1 is a front view of a divers watch according to a first embodiment of the present invention;

FIG. 2 is a cross-sectional view cut along an F2-F2 line in FIG. 1 with a crown screw locked;

FIG. 3 is a perspective view showing a band case, a winding stem pipe, a rotation-stop pin, and a pipe stopper of the divers watch of FIG. 1, all of which are disassembled from each other; and

FIG. 4 is a perspective view showing a band case, a winding stem pipe, and a pipe stopper of a divers watch according to a second embodiment of the present invention, all of which are disassembled from each other.

### DETAILED DESCRIPTION OF THE PREFERRED EMBODIMENTS

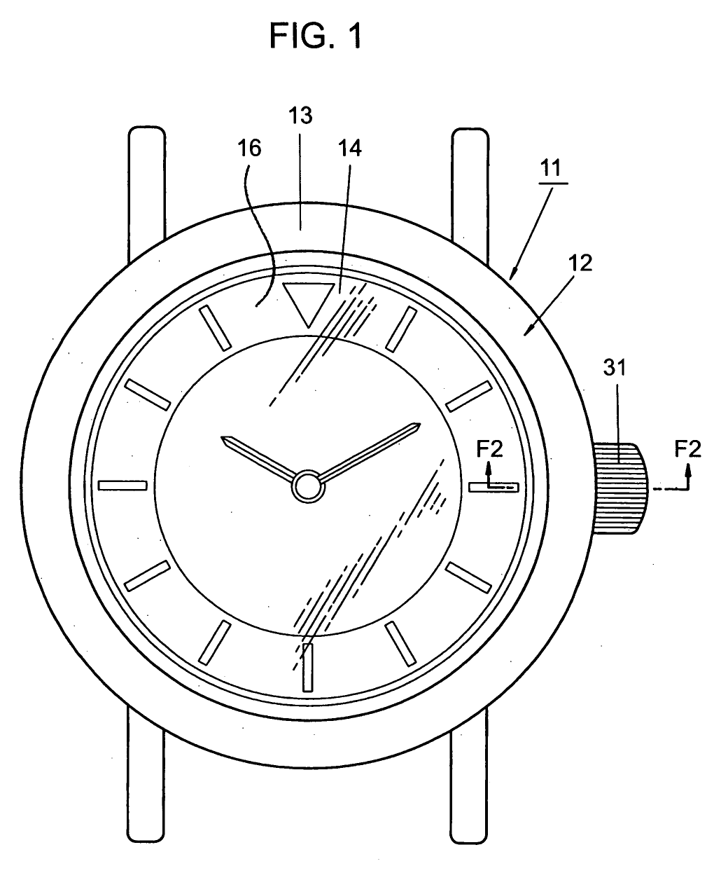

In the below, described is a first embodiment of the present invention by referring to FIGS. 1 to 3.

A reference numeral 11 in FIG. 1 shows a divers watch as a portable watch with the screw lock structure for a crown. This watch 11 accommodates a watch movement, and the like, that are not shown in a watch exterior assembly 12. The watch movement is not restrictive, and may be the one whose power source is a small-sized battery or a spring, the one of a self-winding type, the one equipped for a digital watch displaying time or others in digital form on a dial by quartz oscillator module, or the one as a result of combining the one equipped for a digital watch and the one equipped for others.

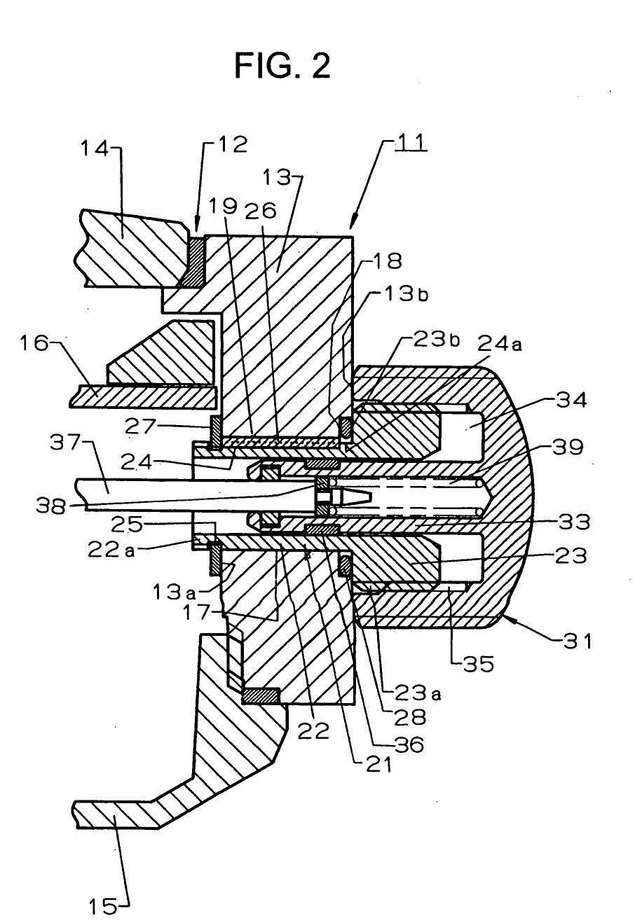

The watch exterior assembly 12 is so formed that a cover glass 14 is attached to be liquid tight over the surface of an annular metallic case band 13, and a case back 15 (refer to FIG. 2) made of metal, and the like, is attached to be liquid tight over the back plane of the case band 13. A dial 16 and others can be seen through the cover glass 14, and the case back 15 can be removable.

As shown in FIG. 2, the case band 13 has, at a part thereof, a pipe-attachment hole 17 going through the case band 13 in the radius direction. One end of the pipe-attachment hole 17 is made open to the intracase-band side, that is, an intracase-band plane 13a facing to the inner space of the watch exterior assembly 12. The other end of the pipe-attachment hole 17 is made open to an extracase-band plane 13b facing to the outside of the watch exterior assembly 12. The extracase-band plane 13b of the case band 13 includes a circular concave section 18. This concave section 18 is made larger in diameter than the pipe-attachment hole 17, and goes through the opening made on the extracase-band side of the hole 17 and is provided concentrically with the opening.

Further, the case band 13 is provided with a pin-receiving groove 19 in parallel to the pipe-attachment hole 17. The pin-receiving groove 19 is made open toward the pipe-attachment hole 17, and formed with one and the other ends thereof opening toward the intracase-band plane 13a and the concave section 18 of the extracase-band plane 13b, respectively.

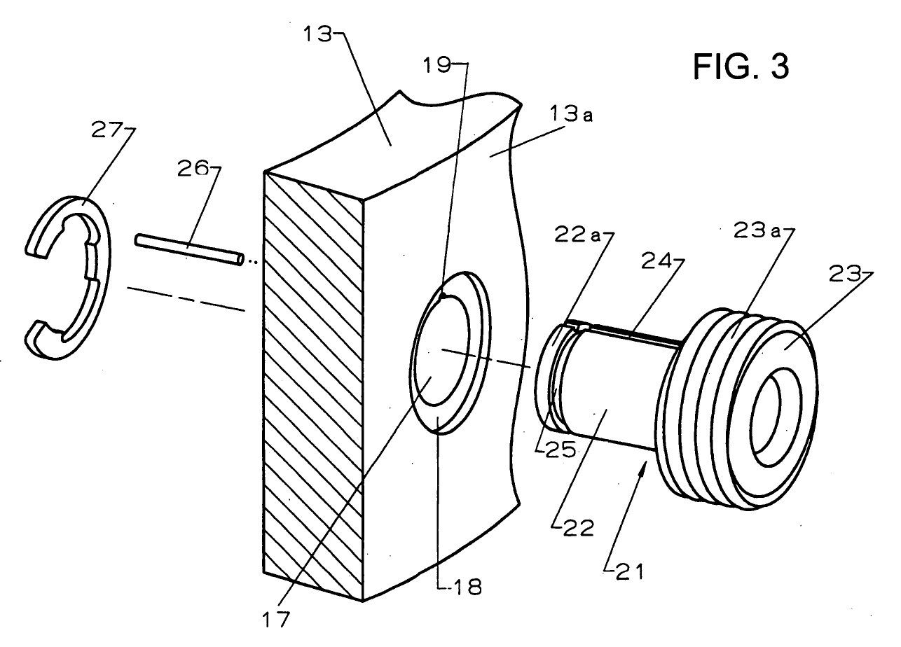

A reference numeral 21 in FIGS. 2 and 3 denotes a metallic winding stem pipe. This pipe 21 goes through the pipe-attachment hole 17, and attached to the case band 13 in a removal manner from the extracase-band side.

In detail, the winding stem pipe 21 is provided with an insertion section 22 to be playably inserted into the pipe-attachment hole 17, an extracase-band end section 23 to be arranged on the extracase-band side, and a pin-receiving groove 24 formed to the insertion section 22.

The outer diameter of the insertion section 22 is made to be slightly smaller than that of the pipe-attachment hole 17. Thereby, between the pipe-attachment hole 17 and the insertion section 22, play for enabling insertion or removal of the insertion section 22 to/from the pipe-attachment hole 17, that is, a slight gap (not shown) is made. The tip section of the insertion section 22 locating furthest from the extracase-band end section 23 forms an intracase-band end section 22a. The insertion section 22 is long enough that the intracase-band end section 22a protrudes to the inner space of the case band 13 (inside of the case band) at the time when the winding stem pipe 21 is defined by position in the extracase-band end section 23 in the axial direction.

The extracase-band end section 23 is provided to the other end at which the intracase-band end section 22a of the insertion section 22 is provided to be a piece. The extracase-band end section 23 is made larger in diameter than the concave section 18, and at the outer rim plane thereof, formed is a male screw section 23a. The plane of the extracase-band end section 23 locating closer to the insertion section 22 is orthogonal to the direction of the axial line of the winding stem pipe 21, and is to be used as an abutment plane 23b abutting to the extracase-band plane 13b.

To the base of the intracase-band end section 22a of the insertion section 22, that is, the part of the intracase-band end section 22a locating closer to the intracase-band plane 13a which is the part protruding to the intracase-band side from the case band 13, formed is, for example, an annular engagement groove 25 opening toward the outer rim plane of this end section 22a.

The pin-receiving groove 24 is provided by extending in the axial direction of the insertion section 22, and opens toward the outer rim plane of the insertion section 22. The pin-receiving groove 24 is formed to across the engagement groove 25, and opens toward the tip plane of the insertion section 22 facing to the intracase-band side. This pin-receiving groove 24 is so made as to correspond to the pin-receiving groove 19 of the case band 13, and is so made as to form a circular hole, for example, opposing to the pin-receiving groove 19. Note herein that, a reference numeral 24a in FIG. 2 shows the groove end of the pin-receiving groove 24 closer to the extracase-band end section 23.

The winding stem pipe 21 inserted into the pipe-attachment hole 17 is fixed to the case band 13 using a rotation-stop pin 26 not to rotate. This pin 26 is located across both pin-receiving grooves 19 and 24 by being inserted into the circular hole formed by the pin-receiving grooves 19 and 24 from the intracase-band side, for example. And it operates as a rotation stopper for preventing the winding stem pipe 21 from rotating in the circumferential direction against the case band 13.

The engagement groove 25 is engaged with a pipe stopper 27 such as an E-shaped stopper in a removable manner. The pipe stopper 27 abuts to the intracase-band plane 13a, and operates to prevent the winding stem pipe 21 from being disengaged from the pipe-attachment hole 17 toward the extracase-band side. The pipe stopper 27 sandwiches, from the case band 13 both inside and outside, the pipe-attachment hole 17 and therearound with the extracase-band end section 23, and attaches the winding stem pipe 21 to the case band 13. Further, the pipe stopper 27 sandwiches, in the axial direction, the rotation-stop pin 26 with the groove end 24a of the pin-receiving groove 24. As such, using the pipe stopper 27 and the groove end 24a of the pin-receiving groove 24, the rotation-stop pin 26 is fixed to its predetermined position to prevent disengagement. Thus, there is no need to include any component specifically designed therefor.

A reference numeral 28 in FIG. 2 denotes an annular waterproof rubber gasket. This gasket 28 is fit in the concave section 18, and is sandwiched between the furthest plane of the concave section 18 and the abutment plane 23b of the extracase-band end section 23 by changing in shape due to its elasticity through compression, for the purpose of achieving waterproof between the case band 13 and the winding stem pipe 21.

The winding stem pipe 21 is attached to the case band 13 in the following procedure. First, with the waterproof gasket 28 fit into the concave section 18, or with the outer rim of the insertion section 22 of the winding stem pipe 21 fit with the waterproof gasket 28, the case band 13 and the pin-receiving grooves 19 and 24 of the winding stem pipe 21 are so positioned as to face to one another, the insertion section 22 is inserted and goes through the pipe-attachment hole 17 from the extracase-band side. Insertion of the insertion section 22 into the pipe-attachment hole 17 is restricted by the abutment plane 23b of the extracase-band end section 23 abutting to the extracase-band plane 13b. At the same time, the engagement groove 25 of the intracase-band end section 22a is positioned at any appropriate position with respect to the intracase-band plane 13a. Responding to completion of such insertion, the waterproof gasket 28 so far free to move is compressed, and the intracase-band end section 22a of the insertion section 22 protrudes to the inside of the case band 13 (inner space of the case band 13).

Next, using as a guide the pin-receiving groove 24 opening toward the tip plane of the intracase-band end section 22a, the rotation-stop pin 26 is inserted from the intracase-band side into a hole made by the groove 24 and the pin-receiving groove 19 of the case band 13. Thus inserted rotation-stop pin 26 snags on both the pin-receiving grooves 19 and 24. In this manner, via the rotation-stop pin 26, the winding stem pipe 21 is prevented from rotating against the case band 13.

Thereafter, the pipe stopper 27 is fit into the engagement groove 25 of the intracase-band end section 22a while making it along the intracase-band plane 13a. As a result, thanks to the pipe-stopper 27 operating to stop disengagement, the winding stem pipe 21 is so retained as not to disengage with the case band 13 toward the extracase-band plane.

With the above procedure, the winding stem pipe 21 is completely attached to the case band 13. Here, alternatively, instead of inserting the rotation-stop pin 26 from the intracase-band side, the winding stem pipe 21 may be attached to the case band 13 by inserting, from the extracase-band side, this pin 26 to the pipe-attachment hole 17 and the pin-receiving groove 19 together with the insertion section 22 with the rotation-stop pin 26 fit with the pin-receiving groove 24 for retention. Then, the insertion section 22 may be attached with the pipe stopper 27 in the intracase-band side.

FIG. 2 shows the state of the case band 13 being attached with the winding stem pipe 21. In this state, the winding stem pipe 21 is biased toward the extracase-band side with elastic rebound of the waterproof gasket 28. And the extracase-band end section 23 abutting to the extracase-band plane 13b and the pipe stopper 27 abutting to the intracase-band plane 13a sandwich the pipe-attachment hole 17 and therearound from inside and outside of the case band 13. Thus, the winding stem pipe 21 is attached to the case band 13 in the axial direction with no rattle. Further, the winding stem pipe 21 is fixed to the case band 13 by the rotation-stop pin 26 not to rotate as described in the foregoing. Accordingly, the winding stem pipe 21 is attached to the case band 13 without brazing or using adhesive.

Therefore, the winding stem pipe 21 can be removed from the case band 13 at the time of maintenance, and the like, with the reverse manner to the assembly procedure described above. To perform removal as such, with the case back 15 removed, the pipe stopper 27 in the intracase-band side is first removed, and then the winding stem pipe 21 playably inserted to the pipe-attachment hole 17 is pulled out to the extracase-band side.

A crown denoted by a reference numeral 31 in FIG. 1 is made of metal, and as shown in FIG. 2, is provided with a crown main section 32 and a crown tube section 33 extending in its entirety in the axial direction from the middle section thereof. To the crown main section 32, an annular clearance groove 34 is provided to enclose the base section of the crown tube section 33. And a female screw section 35 is formed to the inner rim plane of the groove 34 for screw locking. The clearance groove 34 is a part into which the extracase-band end section 23 and an exterior pipe 26 of the winding stem pipe 21 are inserted. The female screw section 35 is screwed together with the male screw section 23a of the extracase-band end section 23 in a removable manner. Through such screwing, exerted is the capability for screw lock not to allow the crown 31 to accidentally rotate when the watch 11 is carried around.

The crown tube section 33 is inserted into the winding stem pipe 21 from the extracase-band side. To an annular gasket attachment groove formed to the outer rim of the tube section 33, an annular waterproof rubber gasket 36 is attached. The waterproof gasket 36 is sandwiched between the inner rim plane of the winding stem pipe 21 and the outer rim plane of the crown tube section 33 by changing in shape due to its elasticity through compression, for the purpose of achieving waterproof therebetween. The crown tube section 33 is inserted with a winding stem 37 of the watch movement from the intracase-band side, and accommodating a coil spring 39 biasing the winding stem 37 in the axial direction via a spring bearing 38. The watch movement rotates in relation with the rotation operation of the crown 31 with the female screw section 35 being disengaged with the second male screw section 23a, in other words, with screw lock released. In such a manner, time adjustment and others are carried out.

Herein, as to the crown 31, the crown tube section 33 thereof is inserted into the winding stem pipe 21 from the extracase-band side with the winding stem 37 connected thereto, and the female screw section 35 of the crown main section 32 is screwed and clamped with the male screw section 23a of the winding stem pipe 21. In this manner, attachment is done. When the crown 31 is screwed into the male screw section 28 to the furthest point, the crown main section 32 is defined by position when abutting to the extracase-band plane 13b of the case band 13 as shown in FIG. 2 so that the extracase-band end section 23 is entirely covered. Here, after such a procedure is through, the winding stem 37 and the watch movement are connected together.

With such assembly completed, the waterproof capability can be exerted and retained under high voltage as below. That is, waterproof between the winding stem pipe 21 and the case band 13 can be secured thanks to the waterproof gasket 28 sandwiched therebetween by changing in shape due to its elasticity through compression. Further, waterproof between the winding stem pipe 21 and the crown tube section 33 internally inserted thereinto can be secured thanks to the waterproof gasket 36 sandwiched therebetween by changing in shape due to its elasticity through compression.

In the divers watch 11 assembled as shown in FIG. 2, the crown 31 is engaged with the male screw section 23a of the extracase-band end section 23 of the winding stem pipe 21 for screw locking. This prevents the crown 31 from accidentally rotating when carried around, whereby time display and others do not change. For time adjustment, for example, the crown 31 is rotated in the reverse direction so as to disengage the crown main section 32 from the extracase-band end section 23. Thus, for the purpose, the crown 31 is pulled out against the spring forces of the coil spring 39.

Responding to the operation of the crown 31, if the screw lock capability of the crown 31 is reduced due to damage or wear-out of the male screw section 28 and the female screw section 35 screwed thereinto, it can be dealt with as follows.

In detail, with the crown 31 removed, by removing the pipe stopper 27 as described in the above from the engagement groove 25 of the intracase-band end section 22a of the winding stem pipe 21, the winding stem pipe 21 playably inserted into the case band 13 without fixation not to be separated therefrom can be pulled out to the extracase-band side along the axial direction.

Accordingly, at the time of maintenance, if the winding stem pipe 21 and the crown 31 are needed to be exchanged, the winding stem pipe 21 and the crown 31 can be separately exchanged. Thanks thereto, for a person asking for repairment, there is no need to exchange the watch exterior assembly 12 including the case band 13, and the like. And, only component exchange will do, favorably reducing the cost payment. What is better, irrespective of whether exchange of the winding stem pipe 21 is required or not, at the time of maintenance, to clean the case band 13 by polishing the extracase-band plane 13b by buffing, for example, the winding stem pipe 21 and others can be removed easily. Thus, the extracase-band end section 23 thereof will be kept of the way during the polishing operation. As such, the polishing operation can be smoothly done, and the extracase-band plane 13b can be polished with reliability.

Moreover, in the assembly state, the pipe-attachment hole 17 and therearound of the case band 13 are sandwiched from inside and outside by the pipe stopper 27 attached to the winding stem pipe 21 and the extracase-band end section 23 of the winding stem pipe 21. With such a structure, even if the portable watch 11 receives any impact when accidentally dropped, for example, the winding stem pipe 21 does not rattle against the case band 13.

Further, at the time of attachment of the winding stem pipe 21 to the case band 13 in the above-described manner, there is no need to screw thereinto the winding stem pipe 21, thereby suppressing stress application due to attachment of the winding stem pipe 21 to the case band 13. Therefore, the strength required for the winding stem pipe 21 and others can be reduced, and at the same time, the design flexibility such as material and thickness of the winding stem pipe 21 can be increased. What is better, the process of forming the pin-receiving groove 19 to the winding stem pipe 21 is easier than the process of forming a screw section, and does not need a process for a male screw section corresponding to the winding stem pipe 21, and a process for a female screw section corresponding to the pipe-attachment hole 17. As such, the process cost can be reduced.

Here, in the first embodiment, the pin-receiving groove 19 of the case band 13 opening toward the pipe-attachment hole 17 may be in such a structure that one end opens toward the intracase-band plane 13a and the other end is closed, or in such a structure that one end opens toward the extracase-band plane 13b and the other end is closed.

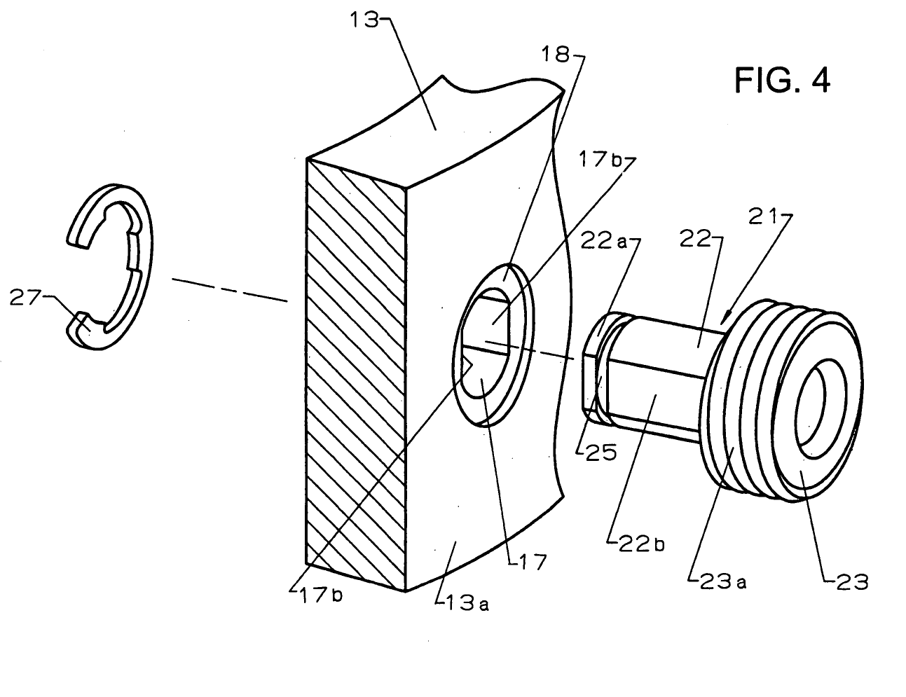

FIG. 4 shows a second embodiment of the present invention. The second embodiment is basically the same as the first embodiment, and thus any identical part to that of the first embodiment is provided with the same reference numeral, and not described again. Described are only parts different from the first embodiment.

In the second embodiment, instead of the pin-receiving groove and the rotation-stop pin for preventing rotation adopted in the first embodiment, the pipe-attachment hole 17 and the insertion section 22 of the winding stem pipe 21 to be playably inserted thereinto are both formed noncircular.

As an example of noncircular shape, the pipe-attachment hole 17 is provided with one or more plane sections, more specifically, a pair of plane sections 17b facing to each other when the winding stem pipe 21 is not inserted into the pipe-attachment hole 17. Also, corresponding to the hole structure, the outer rim plane of the insertion section 22 is also provided with another pair of plane sections 22b (only one of those is shown). These plane sections 17b and 22b operate each as a rotation-stop plane.

The structures other than those described above are the same as those of the first embodiment. Thus, also in this second embodiment, the object of the present invention can be successfully solved with the same effects as the first embodiment. What is better, in the second embodiment, there requires no more part for preventing the winding stem pipe 21 from rotating against the case band 13, thereby rendering the structure simpler. Further, there is no need to process a groove so as to extend in the axial direction against the pipe-attachment hole 17 and the insertion section 22. It is thus considered preferable in terms of cost reduction.

The present invention is not restrictive to the above both embodiments. For example, it can be applied to portable watches such as normal wrist watches or pocket watches that are not asking for waterproof capability under high voltage.

According to the present invention, a winding stem pipe playably inserted into a pipe-attachment hole of a case band without being fixed is prevented from rotating using a rotation-stop pin, and is prevented from being disengaged using a pipe stopper. Accordingly, at the time of maintenance, the pipe stopper is removed and the winding stem pipe can be pulled out toward the extracase-band side. Thus, in a case when the screw rock capability is reduced responding to the operation of the crown, provided is a portable watch achieving component exchange of a crown and therearond, that is, the crown and the winding stem pipe for screw rock it can be separately exchanged.

According to the invention in which a pin-receiving groove of a case band is made open toward an intracase-band plane, and another pin-receiving groove of a winding stem pipe is made open toward the tip plane of an insertion section of the winding stem pipe, provided is a portable watch achieving insertion and removal from the intracase-band side without disturbed by the extracase-band end section of the winding stem pipe.

According to the invention in which a groove end of a pin-receiving groove of a winding stem closer to an extracase-band end section and a pipe stopper sandwich a rotation-stop pin in the axial direction, provided is a portable watch not requiring any component specifically designed for not allowing the rotation-stop pin to be disengaged and for retaining it at the predetermined position.

According to the present invention in which a pipe-attachment hole of a case band and an insertion section of a winding stem pipe playably inserted thereto without fixation are both noncircular to prevent a winding stem pipe from rotating, and the winding stem pipe is prevented from being disengaged toward the extracase-band side using a pipe stopper. Thus, at the time of maintenance, it is possible to pull out the winding stem pipe to the extracase-band side after removing the pipe stopper. With such a structure, in a case when the screw rock capability is reduced responding to the operation of the crown, provided is a portable watch achieving component exchange of a crown and therearond, that is, the crown and the winding stem pipe for screw rock it can be separately exchanged.

1. A portable watch, comprising:
a case band provided with a pipe-attachment hole opening toward both an intracase-band plane and an extracase-band plane, and a pin-receiving groove opening toward the pipe-attachment hole and also toward at least either the intracase-band plane or the extracase-band plane;
a winding stem pipe provided with an insertion section having playably inserted into the pipe-attachment hole in a removable manner from outside of the case band and including an intracase-band end section to be arranged inside of the case band, an extracase-band end section including a male screw section, and another pin-receiving groove opening toward an outer rim plane of the insertion section and facing to the pin-receiving groove;
a rotation-stop pin arranged across both of the pin-receiving grooves;
a pipe stopper engaged with an engagement groove provided to the intracase-band end section in a removable manner to prevent the winding stem pipe from being disengaged; and
a crown including a crown main section formed with a female screw section to be screwed together with the male screw section in a removable manner.

2. A portable watch according to claim 1, wherein the pin-receiving groove of the case band is made open toward the intracase-band plane, and the pin-receiving groove of the winding stem pipe is made open toward a tip plane of the insertion section.

3. A portable watch according to claim 1, wherein the rotation-stop pin is sandwiched, in an axial direction, between a groove end of the pin-receiving groove of the winding stem pipe locating closer to the extracase-band end section and the pipe stopper.

4. A portable watch, comprising:
a case band provided with a noncircular pipe-attachment hole opening toward an intracase-band plane and an extracase-band plane;
a winding stem pipe provided with: an insertion section having an outer rim being noncircular in shape corresponding to the pipe-attachment hole to be playably inserted into the pipe-attachment hole from outside of the case band in a removable manner, and including an intracase-band end section to be arranged inside of the case band; and an extracase-band end section including a male screw section;
a pipe stopper engaged with an engagement groove provided to the intracase-band end section in a removable manner to prevent the winding stem pipe from being disengaged; and
a crown including a crown main section formed with a female screw section to be screwed together with the male screw section in a removable manner.
